(19) United States
(12) Patent Application Publication
(10) Pub. No.: US 2014/0153078 A1
(43) Pub. Date: Jun. 5, 2014

(54) SIMULATION METHOD FOR AN OPTICAL MODULATOR

(71) Applicant: STMICROELECTRONICS SA, Montrouge (FR)

(72) Inventor: Jean-Robert MANOUVRIER, Echirolles (FR)

(73) Assignee: STMICROELECTRONICS SA, Montrouge (FR)

(21) Appl. No.: 14/084,702

(22) Filed: Nov. 20, 2013

(30) Foreign Application Priority Data
Nov. 30, 2012 (FR) 1261496

(51) Int. Cl. G02F 1/015

(52) U.S. Cl. CPC G02F 1/015
USPC 359/279

(57) ABSTRACT

A simulation model is for an optical modulator that may include an optical phase shifter in a semiconductor material structure between two sections of an optical waveguide. The semiconductor material structure may include one of a P-N and P-I-N junction in a plane parallel to an axis of the optical waveguide. The model may include a diode configured to characterize an electrical behavior of the one of the P-N and P-I-N junction such that a change in a global refractive index of the optical phase shifter is expressed, by a coefficient, based upon an amount of charges in the one of the P-N and P-I-N junctions and raised to a power. The coefficient and the power may be empirical values based upon the semiconductor material and a wavelength.

### FIELD OF THE INVENTION

The invention relates to the simulation of optoelectronic components, for example, an optical modulator.

### BACKGROUND OF THE INVENTION

In the field of electronic components, so-called compact simulation models may be used. A compact model is a model that provides a usable output quantity that is a function of an input variable and a set of parameters. SPICE models of electrical components, for example, are compact models.

Optoelectronic components involve electrical and optical quantities. It may be desirable to provide a compact model for an optical modulator that expresses the output power of the modulator according to the electrical control signal of the modulator.

FIG. 1 schematically shows an optical modulator according to the Mach-Zehnder interferometer (MZI) principle. The modulator includes an optical waveguide receiving a power P, which is divided into two branches at a point S. The two branches join again at a point J, one directly and the other via an electro-optic phase shifter 10. Each branch carries half of the original optical power.

An optical wave may be phase shifted because it acts as a carrier wave of frequency f=c/λ, where c is the speed of light, and λ is the wavelength. At point J of the modulator, the carrier waves arriving in the two branches are summed, one having been shifted by φ by the phase shifter 10. The resulting carrier wave has a power of P·cos²(φ/2), neglecting the optical losses.

FIGS. 2A and 2B schematically illustrate cross-sectional views of two types of electro-optic phase shifters. The section plane is perpendicular to the axis of the optical waveguide.

FIG. 2A shows a conventional so-called High-Speed Phase Modulator (HSPM) phase shifter. A dashed circle represents the area crossed by the optical beam where the waveguide connects with the phase shifter.

The phase shifter includes a semiconductor structure, typically silicon, forming a P-N junction 12 in a plane parallel to the axis of the waveguide, and offset from the axis (to the right in the figure). A P-doped region extends to the left of the junction 12, including a thick portion in the optical beam, and a thinner portion beyond. The P-doped region is ended by a P+ doped region on which an anode contact A is formed.

An N-doped region extends to the right of the junction 12 and ends with an N+ doped region carrying a cathode contact C. The section of the structure conforms to the section of the waveguide, here an inverted “T”.

To control the phase shifter of FIG. 2A, a voltage is applied between the anode and cathode contacts A and C, which reverse-biases the junction 12 (the ‘+’ on the cathode and the ‘−’ on the anode). This configuration causes a displacement of the electrons e from the N-region to the cathode and of the holes h from the P-region to the anode, and the creation of a depletion region D on both sides of the junction 12. The carrier concentration in the area crossed by the optical beam is thus modified in accordance with the magnitude of the bias voltage, which results in a corresponding modification of the refractive index of this area.

FIG. 2B shows a conventional so-called P-I-N junction optical phase shifter. The P and N-doped areas of the structure of FIG. 2A have been replaced by a single intrinsic semiconductor zone I. To control this phase shifter, a voltage is applied between the anode and cathode contacts A and C, which forward-biases the junction 12 (the ‘−’ on the cathode and the ‘+’ on the anode). A current is established between the anode and the cathode causing a carrier injection in the intrinsic region I (holes h from the P+ region to area I and electrons e from the N+ region to area I). The carrier concentration is thus modified in accordance with the current, which results in a corresponding modification of the refractive index of the area crossed by the optical beam.

PIN phase shifters have a relatively slow response compared to HSPM phase shifters, but they have a wider range of operation. Optical modulators often include both types of phase shifters arranged in series, the PIN phase shifter being used for fixing a quiescent point, and the HSPM phase shifter serving to modulate the wave around the quiescent point.

An optical modulator is designed to be integrated on a chip with its operating circuit. It may be desirable to simulate the behavior of the entire circuit and the modulator using a single simulation tool. More particularly, it may be desirable to have a compact model to simulate the modulator as if it were an electronic component. However an optical phase shifter is a component whose behavior is governed by a phenomenon of volume distribution of carriers, which may be difficult to formalize in a compact model.

The Drude model may be used to locally determine, in a volume element, the variation Δn of the refractive index and the variation Δα of the absorption coefficient as a function of changes in concentration of holes ΔN_{H} and electrons ΔN_{E}. These equations are expressed in the form:

Δn=efn·ΔN_{E}+hfn·ΔN_{H}

Δα=efa·ΔN_{E}+hfa·ΔN_{H} (1)

where the coefficients efn, hfn, efa and hfa are defined for the material and the wavelength. For silicon and a wavelength of 1300 nm, the values are:
efn=−6.2×10⁻²²
hfn=−6.0×10⁻¹⁸
efa=6.0×10⁻¹⁸
hfa=4.0×10⁻¹⁸

The article entitled, “Electrooptical Effects in Silicon”, by R A Soref et al., IEEE Journal of Quantum Electronics, QE-v 23, n1, January, 1987 found that the Drude model does not take into account that the influences of holes and electrons are different. The article offers the following modified equation for changes in the refractive index:

Δn=efn·(ΔN_{E})^{1.05}+hfn·(ΔN_{H})^{0.8}

The exponents 1.05 and 0.8 are empirical and depend on the material, here silicon.

These equations allow, using the finite element method, the calculation of the refractive index in each node of a mesh discretization of the region crossed by the optical beam. An average refractive index of this region could then be calculated, and the phase shift derived therefrom. But the finite element method may be particularly unsuitable for conventional simulation tools available to the electronic circuit designer.

### SUMMARY OF THE INVENTION

A compact model for an optical modulator may be desirable for the electronic circuit designer to allow simulation of the behavior of the modulator together with the behavior of electronic circuits operating the modulator. This desire may be addressed by using a simulation model for an optical modulator, wherein the modulator includes an optical phase shifter in a semiconductor material configured to be arranged between two sections of an optical waveguide. A P-N or P-I-N junction may be formed in the phase shifter in a plane parallel to the axis of the waveguide. The optical modulator model includes a diode model characterizing the electrical behavior of the junction. A change in the global refractive index of the phase shifter is expressed proportionally to the amount of charges present in the junction region determined from the diode model and raised to a power. The proportionality coefficient and the power are empirical values based upon the semiconductor material and the wavelength.

According to an embodiment, the diode model characterizes the reverse-bias operation of the diode, and the amount of charges is the amount of depletion charges in the junction. According to an embodiment, the diode model characterizes the forward-bias operation of the diode, and the amount of charges is the amount of injection charges in the junction.

According to an embodiment, the change in the refractive index is expressed by the sum of a depletion component proportional, by a first coefficient, to the amount of depletion charges in the junction raised to a first power, and of an injection component, proportional by a second coefficient, to the amount of injection charges in the junction, raised to a second power.

According to an embodiment, a change in a global absorption coefficient of the optical phase shifter may be expressed by the sum of a depletion component proportional, by a third coefficient, to the amount of depletion charges in the junction raised to a third power, and of an injection component proportional, by a fourth coefficient, to the amount of injection charges in the junction, raised to a fourth power. The third and fourth coefficients, and third and fourth powers are empirical values based upon the semiconductor material and the wavelength.

A simulation method for an optical modulator including an optical phase shifter in a semiconductor material configured to be arranged between two sections of an optical waveguide, and a P-N or P-I-N junction formed in the phase shifter in a plane parallel to the axis of the waveguide may include the steps of providing a diode model characterizing the electrical behavior of the junction. The method may also include determining the amount of charges present in the junction region from the diode model, and expressing a change in the global refractive index of the phase shifter proportionally to a power of the amount of charges. The proportionality coefficient and the power are empirical values depending on the semiconductor material and the wavelength.

### BRIEF DESCRIPTION OF THE DRAWINGS

FIG. 1 is a schematic diagram of an MZI modulator in accordance with the prior art.

FIG. 2A is a schematic cross-sectional view of an optical phase shifter in accordance with the prior art.

FIG. 2B is a schematic cross-sectional view of another optical phase shifter in accordance with the prior art.

FIG. 3 is a block diagram of a compact model for an optical modulator in accordance with the present invention.

FIG. 4A is a graph of a phase shift response curve obtained using a compact model for an HSPM optical phase shifter in accordance with the present invention.

FIG. 4B is a graph of an absorption coefficient response curve obtained using a compact model for an HSPM optical phase shifter in accordance with the present invention.

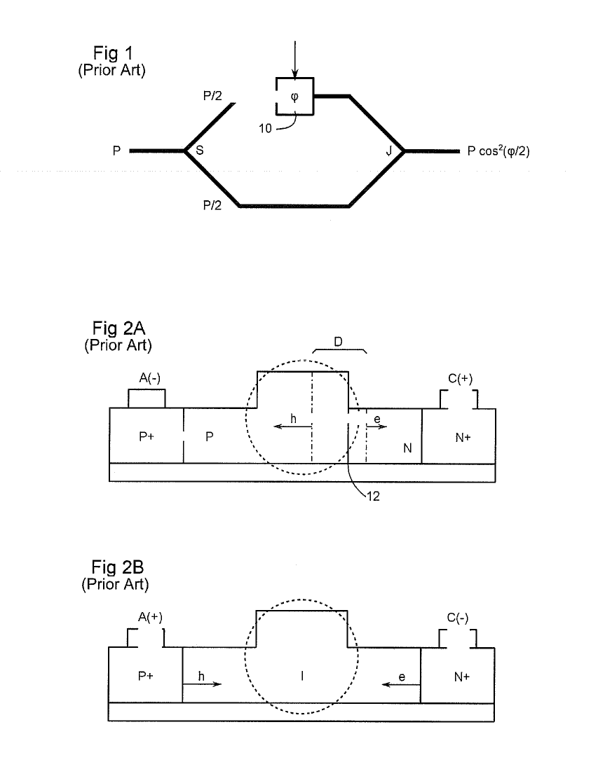

### DETAILED DESCRIPTION OF THE PREFERRED EMBODIMENTS

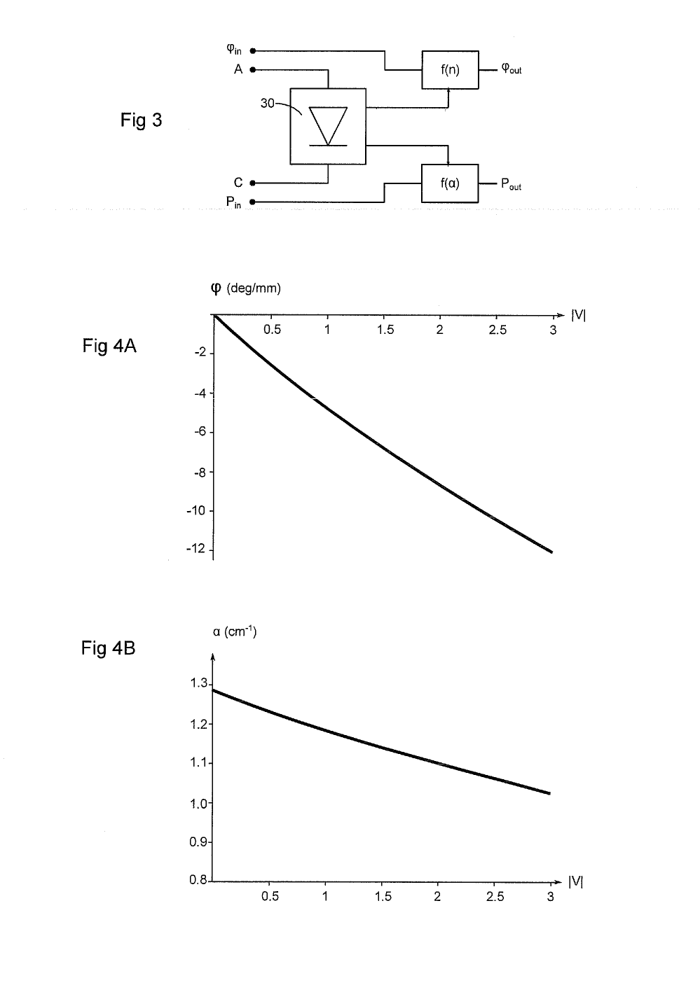

FIG. 3 is a block diagram of an exemplary compact model for an electro-optical phase shifter that may be useful in a model library of a simulation tool for electronic components. The input variables of the model are the electrical modulation signal (voltage or current) to be applied to contacts A and C (anode and cathode) of the structure, and the phase φᵢₙ and power Pᵢₙ of the input optical wave, for example. The phase and the optical power are provided as fictitious electrical quantities, for example, voltages. The output variables are then the phase φₒᵤₜ and the optical power Pₒᵤₜ of the outgoing wave, also represented by fictitious voltages.

The model of the phase shifter includes a model 30 of a semiconductor diode that characterizes the electrical structure of the phase shifter, a P-N diode (FIG. 2A) or a P-I-N diode (FIG. 2B). The diode model 30 receives the signal applied to the terminals A and C. A function f(n) involving parameters of the diode 30 is applied to the signal φᵢₙ to produce the signal φₒᵤₜ, while a function f(α), also involving parameters of diode 30, is applied to the signal Pᵢₙ to produce the signal Pₒᵤₜ.

The function f(n) expresses the phase shift caused by the variation of the refractive index n according to the relationship:

$${ϕ}_{out} = {ϕ}_{in} + {ϕ}_{0} + 2 π \frac{L}{λ} Δ n$$

where φ₀ is the phase shift introduced by the phase shifter at rest, Δn=n−n₀ is the variation of the refractive index relative to the refractive index n₀ of the phase shifter at rest, and L is the length of the phase shifter according to the axis of the optical waveguide. This relationship can also be expressed as follows using the absolute refractive index n:

$${ϕ}_{out} = {ϕ}_{in} + 2 π \frac{L}{λ} n$$

The function f(α) expresses the power loss caused by the variation of the absorption coefficient α according to the relation:

Pₒᵤₜ=Pᵢₙe^{-(α}^{₀}^{+Δ+)L}

where α₀ is the absorption coefficient of the phase shifter at rest, and Δα=α−α₀ is the variation of the absorption coefficient compared to coefficient α₀.

The global refractive index n (or its variation Δn) and the global absorption coefficient α (or its variation Δα) remain to be determined. These values are referred to as “global” because they reflect the overall behavior of the phase shifter, unlike the “local” values used in the Drude model. These variables may be expressed as a function of the quantity of charges present in the junction region of the diode structure of the phase shifter. The amount of charges indiscriminately involves holes and electrons, and may be a relatively easily computable global value based on variables and parameters involved in the diode model 30.

To achieve a dynamic phase shift, the junction (of P-N or P-I-N type) is typically used in reverse bias to maintain a high bandwidth for handling fast signals (HSPM phase shifter, FIG. 2A). To achieve a static phase shift, a P-N or P-I-N junction is typically used in a forward bias by injecting a current that introduces excess charges (FIG. 2B). This type of phase shifter achieves larger phase shifts, but its limited bandwidth makes it unsuitable for a dynamic use. Generally, a P-I-N diode is preferred for static phase shifting because it introduces less optical loss than a P-N diode.

In the reverse-bias mode of a P-N or P-I-N diode, the charge variation originates from charge depletion. Thus, evacuation of charges from the path of the waveguide causes a reduction in the absorption coefficient and the refractive index.

In the forward-bias mode of a P-N or P-I-N diode, the charge variation originates from the stored charges induced by current injection. Adding charges in the path of the waveguide increases the absorption coefficient and the refractive index.

In the reverse-bias mode, the depletion charge is determined by the following equation governing the behavior of a reverse-biased diode.

$${Q}_{J} = \int {C}_{J} d V = \frac{{C}_{J 0}}{L} \frac{{V}_{bi}}{1 - MJ} ( 1 - {( 1 - \frac{V}{{V}_{bi}} )}^{1 - MJ} )$$

where C_{J} is the capacitance of the P-N junction and V is the reverse-bias voltage of the junction. The voltage V, being a reverse-bias voltage is normally negative, but it can reach the positive value V_{bi} before the junction becomes forward-biased. In addition:
C_{J0}: capacitance of the junction at zero bias, a parameter of the diode model 30;
V_{bi}: internal voltage (of the order of 0.7 V for silicon), a parameter of the diode model 30, and depends on temperature; and
MJ: gradient index of the junction (between 0.3 and 0.5 depending on the used doping levels), a parameter of the diode model 30.

The amount of depletion charges is:

$${N}_{d} = \frac{{Q}_{J}}{q}$$

where q is the elementary charge of an electron.

In the forward-bias mode, the charge diffusion is determined by the following equation governing the behavior of a forward-biased diode:

$${Q}_{DIFF} = \frac{{τ}_{T 0} \cdot {I}_{D}}{L}$$

where τ_{T0} is the transit time and I_{D} is the bias current of the P-I-N junction. The transit time is a parameter of the diode model 30 and depends on temperature.

The amount of injection charges is:

$${N}_{i} = \frac{{Q}_{DIFF}}{q}$$

From the charge amounts expressed above, the variations of the refractive index and of the absorption coefficient may be expressed as follows.

For an HSPM phase shifter:

Δn_{d}=−ncd·|N_{d}|^{ned}

Δα_{d}=−acd·|N_{d}|^{aed} (2)

And for a PIN phase shifter:

Δnᵢ=nci·|Nᵢ|^{nei}

Δαᵢ=aci·|Nᵢ|^{aei} (3)

The expressions (2) and (3) govern the behavior of two different types of phase shifters in their normal operating mode. In a simulation, it may be particularly advantageous to also model a component outside its normal operating mode to study its limit behavior, such as the HSPM phase shifter in forward-bias mode and the PIN phase shifter in reverse-bias mode. For this purpose, the variations of the global refractive index Δn and of the global absorption coefficient Δα are expressed:

Δn=Δn_{d}+Δnᵢ

Δα=Δα_{d}+Δαᵢ

The parameters ncd, ned, acd, aed, nci, nei, aci, aei are constants determined empirically depending on the semiconductor material and the wavelength. They do not depend on the structure of the phase shifter, HSPM or PIN—the structure of the phase shifter is typically only involved in the calculation of charge quantities, depending on parameters of the diode model 30.

Since the temperature is involved in the model 30, the behavior of the phase shifter according to temperature can also be simulated. As an example, for silicon and a wavelength of 1310 nm, the following numerical expressions were found:

Δn=−1.14×10⁻¹⁴·|N_{d}|+9.8×10⁻¹⁰|Nᵢ|^{0.6}

Δα=−6.6×10⁻⁹·|N_{d}|+5.3×10⁻⁴|Nᵢ|^{0.6}

FIGS. 4A and 4B are examples of evolution curves of the phase, expressed in degrees per millimeter of length of the phase shifter, and of the absorption coefficient, in cm−1, produced by a reverse-bias phase shifter model (HPSM type). An extraction of the model parameters may provide a margin of accuracy below 5%, compared to measurements made on the real phase shifter.

1-9. (canceled)

10. A simulation model for an optical modulator comprising an optical phase shifter comprising a semiconductor material structure to be coupled between two sections of an optical waveguide, the semiconductor material structure having a junction in a plane parallel to a longitudinal axis of the optical waveguide, the simulation model comprising:
a diode model configured to characterize an electrical behavior of the junction such that a change in a global refractive index of the optical phase shifter is expressed, by a coefficient, based upon an amount of charges in the junction, and raised to a power, the coefficient and the power being empirical values based upon the semiconductor material and a wavelength.

11. The simulation model according to claim 10, wherein said diode model is configured to characterize the electrical behavior of the junction such that the change in a global refractive index of the optical phase shifter is expressed, by a coefficient, proportional to the amount of charges in the junction, and raised to a power.

12. The simulation model according to claim 10, wherein the global refractive index comprises a refractive index indicative of overall behavior of the optical phase shifter.

13. The simulation model according to claim 10, wherein the junction comprises one a P-N and P-I-N junction.

14. The simulation model according to claim 10, wherein said diode model is configured to characterize a reverse-bias operation thereof, and wherein the amount of charges comprises an amount of depletion charges in the junction.

15. The simulation model according to claim 10, wherein said diode model is configured to characterize a forward-bias operation thereof, and wherein the amount of charges comprises an amount of injection charges in the junction.

16. The simulation model according to claim 10, wherein the change in the global refractive index comprises a sum of a depletion component proportional, by a first coefficient, to an amount of depletion charges in the junction, raised to a first power, and an injection component, proportional by a second coefficient, to an amount of injection charges in the junction, raised to a second power.

17. The simulation model according to claim 10, wherein a change in a absorption coefficient of the optical phase shifter comprises a sum of a depletion component, proportional by a third coefficient, to an amount of depletion charges in the junction, raised to a third power, and an injection component, proportional by a fourth coefficient, to an amount of injection charges in the junction, raised to a fourth power; and wherein the third and fourth coefficients, and third and fourth powers comprise empirical values based upon the semiconductor material and the wavelength.

18. A simulation method for an optical modulator comprising an optical phase shifter comprising a semiconductor material structure to be coupled between two sections of an optical waveguide, the semiconductor material structure having a junction, the method comprising:
characterizing electrical behavior of the junction by at least
determining an amount of charges in the junction, and
expressing a change in a global refractive index of the optical phase shifter with a coefficient based upon a power of the amount of charges, wherein the coefficient and the power are based upon at least one of the semiconductor material and a wavelength.

19. The method according to claim 18, wherein the change in the global refractive index is expressed with a coefficient proportional to the power of the amount of charges.

20. The method according to claim 18, wherein the global refractive index comprises a refractive index indicative of overall behavior of the optical phase shifter.

21. The method according to claim 18, wherein characterizing the electrical behavior comprises characterizing a reverse-bias operation, and wherein the amount of charges comprises an amount of depletion charges in the junction.

22. The method according to claim 18, wherein characterizing the electrical behavior comprises characterizing a forward-bias operation, and wherein the amount of charges comprises an amount of injection charges in the junction.

23. The method according to claim 18, wherein determining the amount of charges in the junction comprises determining an amount of depletion charges in the junction, and determining an amount of injection charges in the junction; and wherein expressing the change in the refractive index comprises expressing the change in the refractive index as a linear combination of the amounts of depletion charges and injection charges raised to respective powers.

24. A simulation method for an optical modulator comprising an optical phase shifter comprising a semiconductor material structure to be coupled between two sections of an optical waveguide, the semiconductor material structure having a junction in a plane parallel to a longitudinal axis of the optical waveguide, the method comprising:
characterizing electrical behavior of the junction by at least
determining an amount of charges in the junction, and
expressing a change in a refractive index of the optical phase shifter with a coefficient based upon a power of the amount of charges, wherein the coefficient and the power are based upon the semiconductor material and a wavelength.

25. The method according to claim 24, wherein the change in the refractive index is expressed with a coefficient proportional to the power of the amount of charges.

26. The method according to claim 24, wherein characterizing the electrical behavior comprises characterizing a reverse-bias operation, and wherein the amount of charges comprises an amount of depletion charges in the junction.

27. The method according to claim 24, wherein characterizing the electrical behavior comprises characterizing a forward-bias operation, and wherein the amount of charges comprises an amount of injection charges in the junction.

28. The method according to claim 24, wherein determining the amount of charges in the junction comprises determining an amount of depletion charges in the junction, and determining an amount of injection charges in the junction; and wherein expressing the change in the refractive index comprises expressing the change in the refractive index as a linear combination of the amounts of depletion charges and injection charges raised to respective powers.
